(19) United States
(12) Patent Application Publication
(10) Pub. No.: US 2023/0177258 A1
(43) Pub. Date: Jun. 8, 2023

(54) SHARED ANNOTATION OF MEDIA SUB-CONTENT

(71) Applicant: AT&T Intellectual Property I, L.P., Atlanta, GA (US)

(72) Inventors: Richard Palazzo, Stewartsville, NJ (US); Brian M. Novack, St. Louis, MO (US); Rashmi Palamadai, Naperville, IL (US); Tan Xu, Bridgewater, NJ (US); Eric Zavesky, Austin, TX (US); Ari Craine, Marietta, GA (US); Robert Koch, Peachtree Corners, GA (US)

(21) Appl. No.: 17/541,126

(22) Filed: Dec. 2, 2021

(51) Int. Cl. G06F 40/169; G06F 3/01; G06F 3/0483; G06F 3/16

(52) U.S. Cl. CPC G06F 40/169; G06F 3/013; G06F 3/0483; G06F 3/167

(57) ABSTRACT

The disclosed technology is directed towards determining a sub-content element within electronically presented media content based on where a user is currently gazing within the content presentation. The sub-content elements of the book have been previously mapped to their respective page and coordinates on the page, for example. As a more particular example, a user can be gazing at a certain paragraph on a displayed page of an electronic book, and that information can be detected and used to associate an annotation with that paragraph for personal output and/or sharing with others. A user can input the annotation data in various ways, including verbally for speech recognition or for audio replay. Queries regarding a gazed-at sub-content element can also be handled, including for books and video such as movies,

### TECHNICAL FIELD

The subject application relates to the association of user provided content with media content, and related embodiments.

### BACKGROUND

Users who consume media content via electronic means such as an electronic reader (e-reader) device, such as an electronic book or movie, do not have a way to interact with the content. For example, a user may want to “put down” a thought with respect to a particular paragraph of a book, but has to do so indirectly, such as by physically writing the thought onto paper, typing it in as text such as on a smartphone or into a text editor program, or possibly leaving a voice memo. The user also may have to identify the relevant location in the book in some way for later recollection/association with the thought, e.g. record the title, page number and some more particular identifier such as the second paragraph, the third quote on the page, or the like.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a representation of an example electronic reader (e-reader) device that facilitates the association of media content with user-provided data, in accordance with various aspects and embodiments of the subject disclosure.

FIG. 2 is a representation of mapping a display of a page of content to a model to determine e-reader display coordinates of portions of content and sub-content portions on the page, in accordance with various aspects and embodiments of the subject disclosure.

FIG. 3 is a representation of an example e-reader device that determines what sub-content of a page is currently being viewed based on where the user reader is gazing at the page, in accordance with various aspects and embodiments of the subject disclosure.

FIG. 4 is a representation of an example e-reader device that offers the ability for a user to add a spoken annotation for associating with the sub-content of a page currently being viewed, in accordance with various aspects and embodiments of the subject disclosure.

FIG. 5 is a representation of an example data structure that relates user-provided annotation data to sub-content of media content, in accordance with various aspects and embodiments of the subject disclosure.

FIG. 6 is a representation of an example e-reader device of one user reader that views the shared annotation of another user reader in association with the sub-content associated with that annotation, in accordance with various aspects and embodiments of the subject disclosure.

FIG. 7 is a representation of an example e-reader device of one user reader that views the shared annotation of yet another user reader in association with the sub-content associated with that annotation, in accordance with various aspects and embodiments of the subject disclosure.

FIG. 8 is a representation of an example data structure that relates multiple annotation datasets to different sub-content of media content, in accordance with various aspects and embodiments of the subject disclosure

FIG. 9 is a representation of an example e-reader device that facilitates posting annotation data to a social media account, in accordance with various aspects and embodiments of the subject disclosure.

FIG. 10 is a representation of an example e-reader device that provides recommendations based on a user's gaze data, in accordance with various aspects and embodiments of the subject disclosure.

FIG. 11 is a representation of a movie scene displayed on an electronic playback device that facilitates interaction with the movie scene based on gaze data of a user viewer, in accordance with various aspects and embodiments of the subject disclosure.

FIG. 12 is a flow diagram representing example operations related to mapping eye gaze data to sub-content of media content to relate annotation data with the sub-content, in accordance with various aspects and embodiments of the subject disclosure.

FIG. 13 is a flow diagram representing example operations related to receiving user input and relating the user input, based on gaze data of the user, with sub-content of media content, in accordance with various aspects and embodiments of the subject disclosure.

FIG. 14 is a flow diagram representing example operations related to determining sub-content of media content based on user gaze data and outputting text annotation data in association with the sub-content, in accordance with various aspects and embodiments of the subject disclosure.

FIG. 15 illustrates an example block diagram of an example mobile handset operable to engage in a system architecture that facilitates wireless communications according to one or more embodiments described herein.

FIG. 16 illustrates an example block diagram of an example computer/machine system operable to engage in a system architecture that facilitates wireless communications according to one or more embodiments described herein.

### DETAILED DESCRIPTION

The technology described herein is generally directed towards determining where users are identifying a portion of content (sub-content) that is a portion of more complete media content that is presented for display to a user at a given point in time. Eye tracking/gaze detection determines where a user is looking (the gaze zone) on a display. The sub-content portions (elements) are previously mapped to their displayed locations on an electronic reader (e-reader) device, for example, such that a page of paragraphs, figures, sentences, quotes and the like are separable elements from each other. In this way, a user's current gaze zone maps back to a particular sub-content element.

By mapping the gaze of a user who is consuming media content to a sub-content element, a user may, in a straightforward way, create and share annotation data that relates to the sub-content element of the media being presented. For example, speech input such as spoken annotation data can be recognized as text that can then be associated with the sub-content element at which the user was gazing at the time of the user's speech input. The text can be displayed in association with the sub-content element, both to the user and to one or more other users with which the user wants to share the annotation data.

While examples are described herein primarily based on an electronic book (e-book) as the media type, the technology is applicable to other applications as well, including audio, video, and others. Using an e-book as the media type for example, sub-content may include, but is not limited to, a figure, a line of text, a sentence, a paragraph, or a section of the complete content that is presented at any point in time.

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, can be utilized interchangeably in the application, and can refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

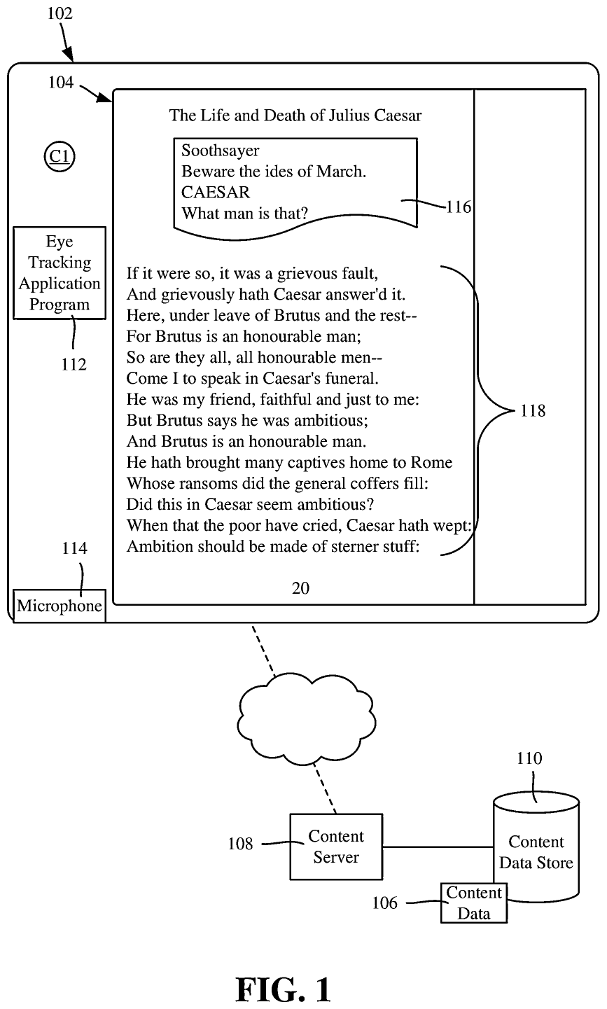

FIG. 1 shows an example e-book reader 102 displaying a page 104 of media content formatted for e-book consumption via an electronic book reader application program. The content data 106 is obtained from a content server 108 coupled to a content data store 110. The content can be previously downloaded and saved, or accessed via an active communications link, such as streamed from the content data store 110 via the content server 108 in communication with the electronic book reader application program on the device.

In FIG. 1, the e-book reader 102 includes a camera Cl facing the user/reader, coupled to an eye tracking application program 112. The example e-book reader 102 also includes a microphone 114 generally configured to detect user speech. Other user input means are not shown, but can, for example, include a touch/pen-sensitive display, such as coupled to handwriting recognition software, a keyboard, and so forth.

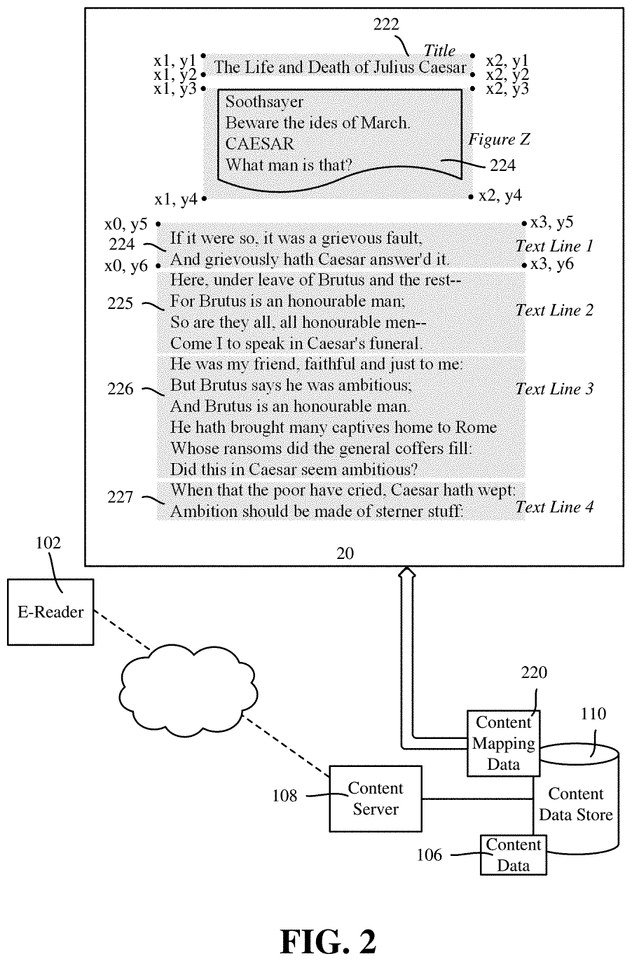

The displayed page 104 in the example of FIG. 1 includes a FIG. 116 and a section 118 containing various sentences. The sentences can, for example, be separate sub-content elements, as described with reference to FIG. 2.

At a time prior to the user accessing the content, the content server 108 has mapped a display of each page (or point in time for media such as audio or video) of the content to a model. In doing so, the content is parsed such that portions, referred to as sub-content elements, may be identified and assigned coordinates on an electronic reader display. The coordinates may be, for instance, x/y coordinates that correspond to points on an e-reader display when the page is presented for display.

The map for each page, including the coordinate designations for each element of sub-content on that page, may be stored as content display mapping data 220. Thus, for example, the title 222 is mapped to coordinates x1, y1, x2, y2, x2, y1 and x2, y2. The figure “Z” labeled 224 is mapped to coordinates x1, y3, x2, y3, x1, y4 and x2, y4. Four sentences, or lines of text 224-227 are also shown as separately mapped to sets of coordinates; for purposes of brevity, only the coordinates for the line of text 224 are shown in FIG. 2, with the respective other lines of text understood to have been similarly mapped to their respective coordinates.

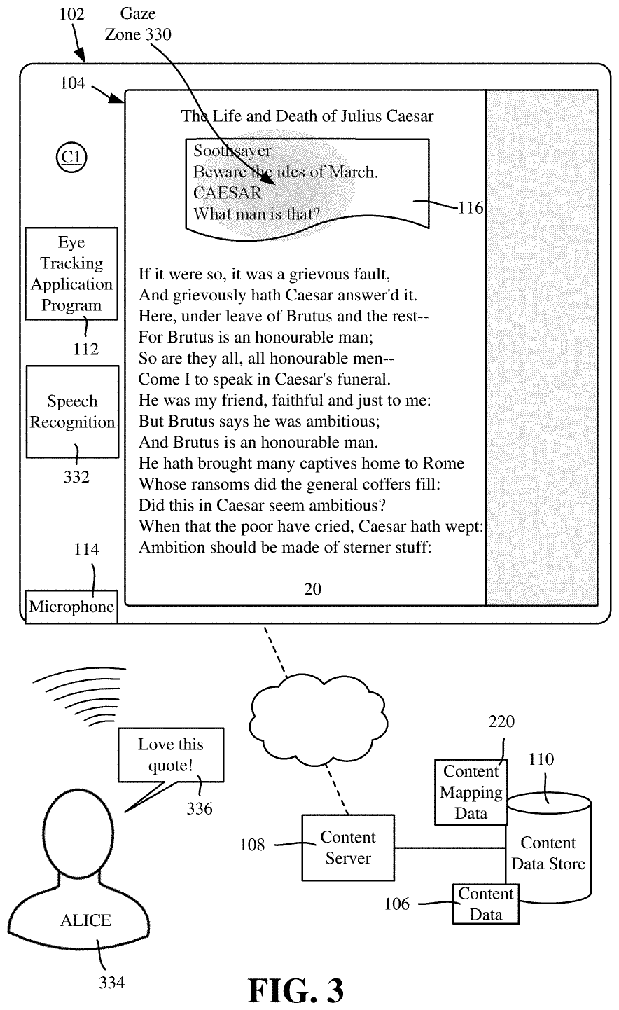

The content page 104 may be presented to a user with the page either having been pre-stored on the user's device or fetched from the content database when requested by the user/e-book reader application program. While the page 104 is presented for display to the user, as represented in FIG. 3 the eye tracking application program makes use of the camera Cl to track the gaze focus area of the user's eyes. A gaze zone 330 is thus captured and can be represented using x and y coordinates, with the center of the zone representing the current gaze point for the user on the display. The gaze point may represent the highest level of certainty of the user's gaze at any point in time. Less certain focus points can also can be represented by x and y coordinates that radiate out from the center point. Although the gaze zone 330 is represented as overlapping ovals in FIG. 3 for purposes of illustration, the gaze zone need not be represented visually on the user's display.

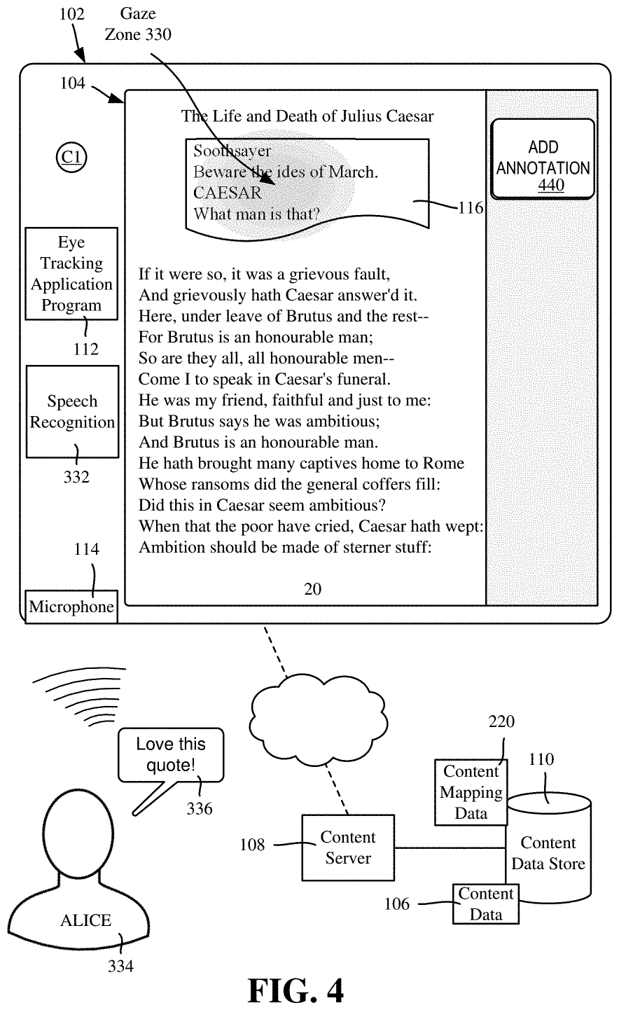

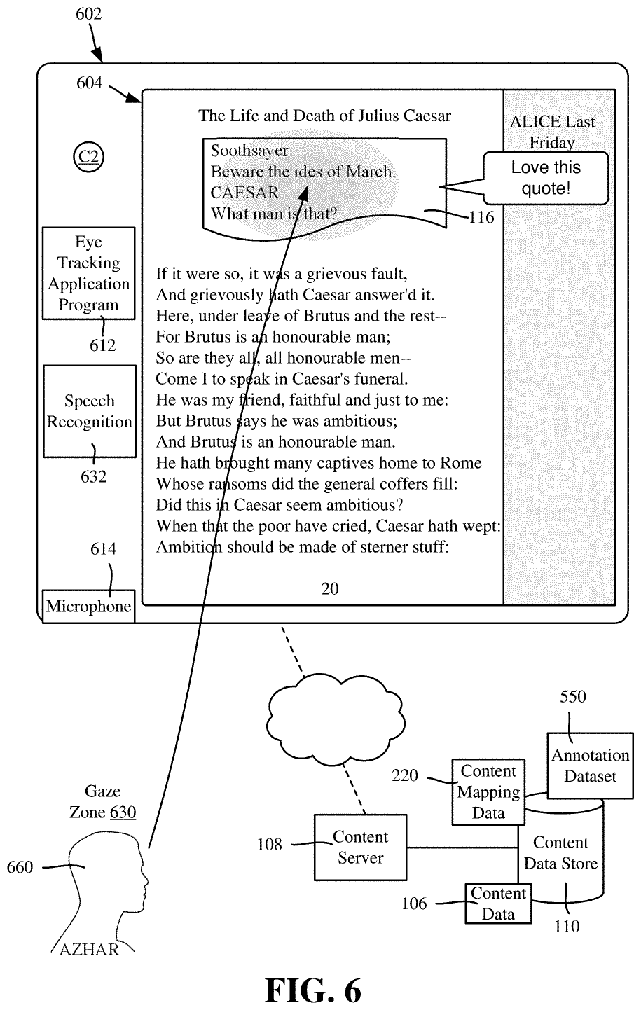

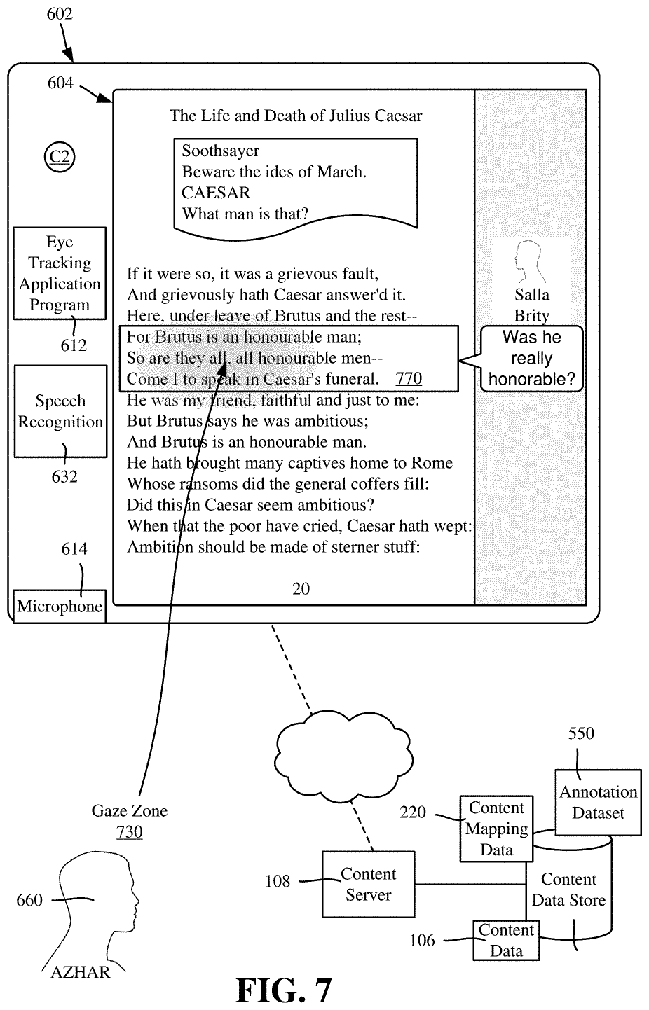

Turning to detection of a gaze zone encounter, consider that the user (ALICE 334) speaks “Love this quote!” (block 336) while gazing that the sub-content figure element 116. When this occurs, the microphone detects the speaking/audio signal, and in response, as shown in FIG. 4 an interactive (e.g., “ADD ANNOTATION”) button 440 is displayed on the device 102. Note that the gaze detection can be regularly (e.g., continuously) occurring, and for example can be sent as gaze data to the content server 108, or if the content mapping data 220 is stored on the e-book reader device 102, can be sent to the eye tracking application program 112. Gaze detection alternatively can be sent only in response to the user's speech, however as described herein with reference to FIGS. 6 and 7, it may be desirable to send the gaze data regularly, even without user interaction, for example to display someone else's shared annotation data.

It is also possible that the user is not looking directly at something when she speaks the annotation. For example, consider a user that has reached the end of the page who exclaims “I loved that quote.” The system can interact with her, e.g., highlight a quote on the page and ask for confirmation as to whether she meant the highlighted quote, and if not, a next one, and so on. If there are multiple candidate sub-content elements on the page, the system can infer from user context/content as to which element the user meant, e.g., “Joe's response was perfect” selects a most likely candidate sub-content element stated by the character Joe, e.g., for user confirmation.

In any event, the user's gaze zone coordinates are compared with the mapping data 220 at the map of the currently displayed page that includes the x and y coordinates of elements of sub-content elements on the page. In this way, while consuming the content, the user can choose to add an annotation that may be later retrieved and presented to the reader herself and/or to another user. In this example, the user has invoked the microphone 114 enter the annotation data. The annotation may be, but is not limited to, a spoken audio file, speech that is converted to text, text entered by the user, a video entered by the user, an icon, or another file that the user may retrieve and add as an annotation.

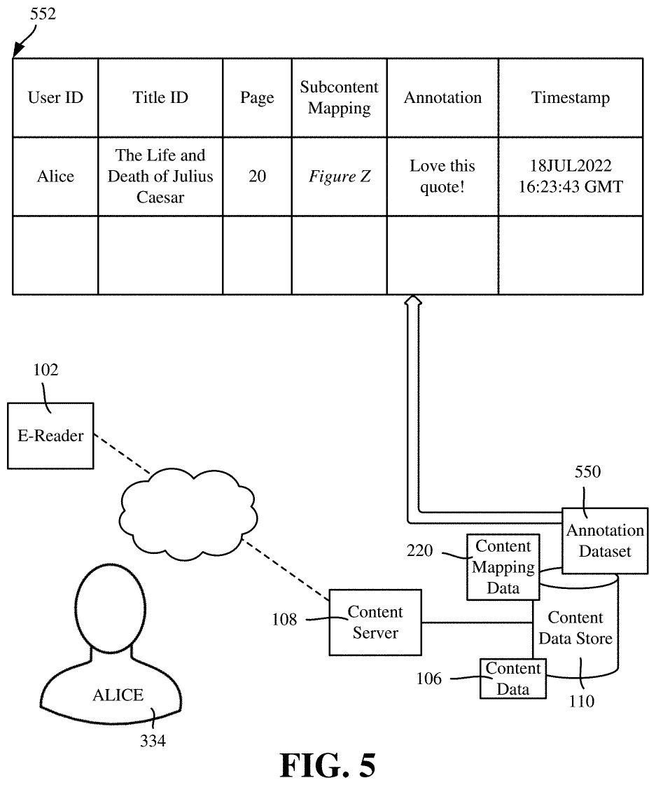

Because the eye tracking application program 112 knows, using the page mapping data, what element of sub-content the user is looking at when she adds the annotation, as shown in FIG. 5, the annotation may be saved as an annotation dataset 550 in an annotation data store (e.g., part of the content data store 110) and associated with the user. In the example data structure 552 (e.g., database record) of FIG. 5, the annotation dataset 550 includes the user ID, a content title identifier (shown in FIG. 5 as the title, but in general a more unique title identifier is used since media content sometimes shares the same title), the page number, and the sub-content on that page are maintained in association with the annotation data (or a link to the annotation data). The time and location (not explicitly shown) of the user at the moment the annotation was created also may be recorded.

As shown in FIG. 6, the saved annotation data can be presented to (shared with) another user 660, AZHAR, viewing on a similar device. In a like manner, the gaze of the other user 660 may be tracked and compared with the sub-content mapping data 220 (or a downloaded instance thereof) of elements on the page. In this manner, when the other user 660 reaches (gazes at) the sub-content element that was previously annotated by the first user, the first user's annotation may be presented to the second user 660. In this example, the first user “ALICE” is identified with a display of the annotation, along with an indication of when the annotation was created.

The circle of users that may share annotations may be determined using a list of permissible users, for example, that are associated with the first and/or second user. For instance, this may be social media connections for the second user or another closed group of other users. In this manner, a group such as a book club, a class, a set of researchers, or other group may communicate and share their annotations with one another.

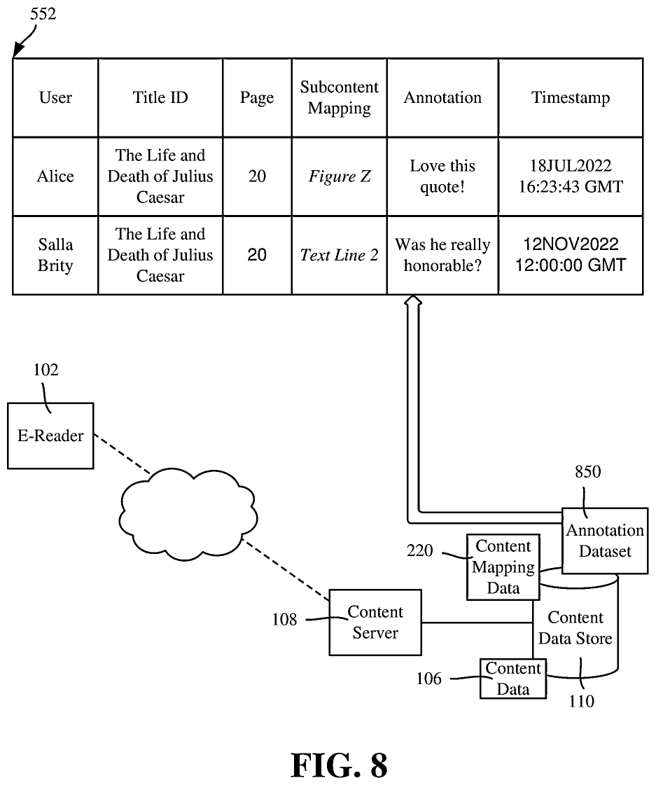

FIG. 7 shows another example of annotation data from a professional or celebrity reviewer, e.g., that the user 660 has registered for receiving annotation data therefrom. This is not limited to a circle of friends, but an opt-in choice for a user. In this case, the annotation data from that reviewer has popped up proximate the sub-content element 770 based on the (now moved) gaze data 730 of the user 660. FIG. 8 shows how the data structure 552 is updated and used for this additional annotation data.

A situation may occur in which the sub-content being identified may be mapped to more than one potential element. For example, upon reaching a paragraph while reading, it may not be clear whether the annotation is associated with the paragraph, a line within the paragraph, or a sentence within the paragraph. In this case, the context of the annotation itself may be used to associate and identify which sub-content element is being referenced. Interaction with the user can be used if needed, including for difficult conflicts, and/or for confirmation.

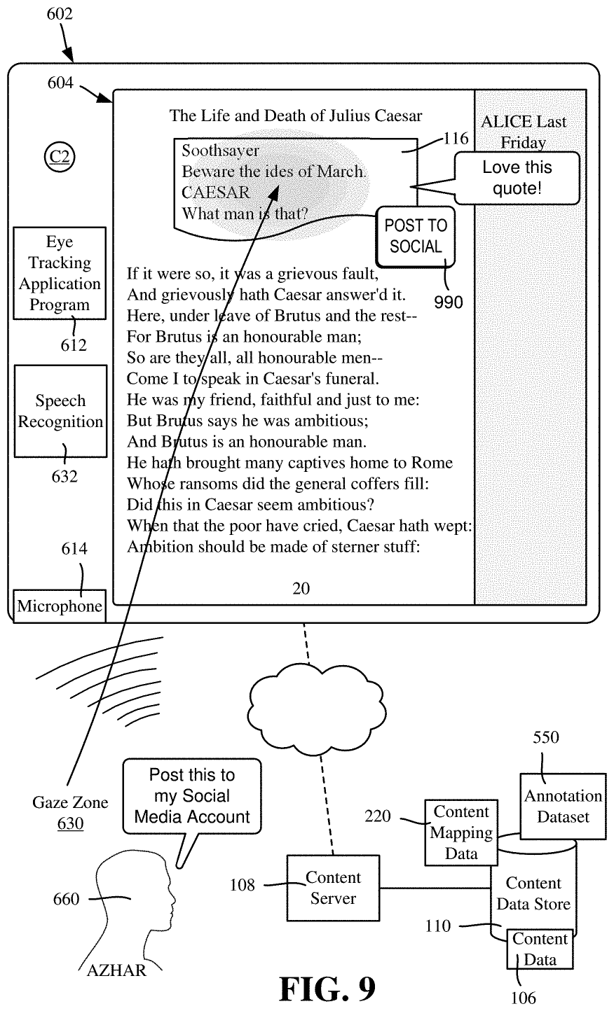

As shown in FIG. 9, an option may exist for a user who is consuming the media to capture and post an element of the sub-content to a social group outside of the annotation system. For example, the user 660 may wish to post the sub-content, optionally accompanied by his own annotation, on a social media site. This can be done via speech, possibly accompanied by a need to interact for confirmation via a “POST TO SOCIAL” button 990 or the like. The entire screen can be shared, or a portion being gazed at, for example.

It may be that only certain elements of sub-content are available for such social posting. Those elements may be indicated by a visual indication on the display, e.g. when the user requests posting. Furthermore, the posting of the previously copyrighted material by the original creator may constitute and be recorded as a micro-license for the user to use that subcontinent for their own purpose. The creator of the content may receive acknowledgment of the original sub-content, they may also receive a monetary remuneration for the license, or the license may add to a count that includes the sharing of the sub-content by other users. This may be published to represent that the sub-content is, for instance, trending at the time or in the Top 10 of sub-content shared this week.

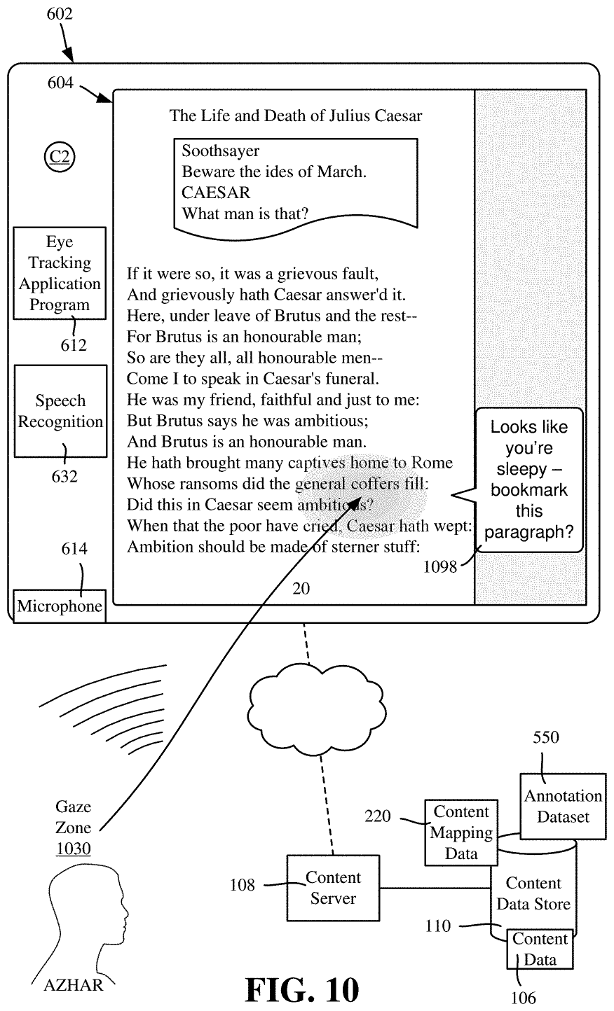

FIG. 10 shows an example of another concept, namely bookmark recommendations.

The content server 108 and/or eye tracking application program 612 may analyze the gaze zone data that is obtained from the user, and look for data that may indicate that the user is distracted, falling asleep, or otherwise not efficiently digesting the material. For example, if the gaze zone data indicates that the user's pace of reading has slowed as compared with the most recent previous pace, or if the user's eyes are detected as closing for a threshold period of time, or if the gaze zone data indicates that the user is re-reading material, the user may be presented with a recommendation. In this example, the recommendation may be, for instance, a popup recommendation 1098 to insert a bookmark at a specific location on the page that is related to a sub-content element, rather than on the page as a whole. A user also may wish to share calendar data with the software of the device 602 so that a user is made aware of an upcoming event such as a scheduled meeting or other appointment, and does not overlook the event due to being consumed by reading. Insertion of a bookmark can likewise be recommended, e.g., “You have a scheduled event at 9:30 am, bookmark this paragraph?” or the like.

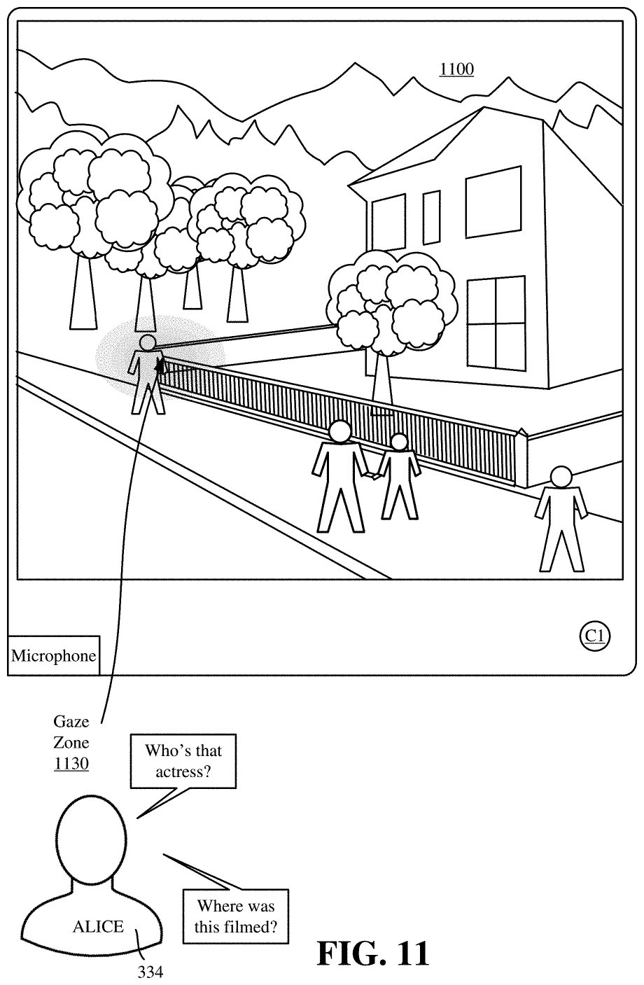

FIG. 11 depicts another concept, namely user interaction with video or other media types such as audio. Video content may be mapped for a specific scene 1100 (e.g., a set of frames). Specific frame(s) and metadata associated with the frame(s) may be sent along with the content to the user. The metadata may be associated with each element of sub-content being presented, for instance, an area or other portion of the display, which can be a 3D region in a virtual reality presentation, a verse of a song for audio content, and so on.

The user can use an interface to assign or retrieve annotations as before, e.g., “This is my favorite scene!” to be shared with others, or later for her own consumption. A user also may use the interface to access the metadata associated with specific x, y sub-content coordinates on the display of the frame.

Further, as shown in FIG. 11, the gaze zone 1130 need not be related to an annotation, but instead may be the subject of one or more queries. In this example, the user 334 is requesting information about an actress appearing within the gaze zone 1130, which can be looked up in a suitable data store and returned as a response. A more general query for a scene, in this example, “Where was this filmed?” can be made as well, not necessarily related to the more focused current gaze zone.

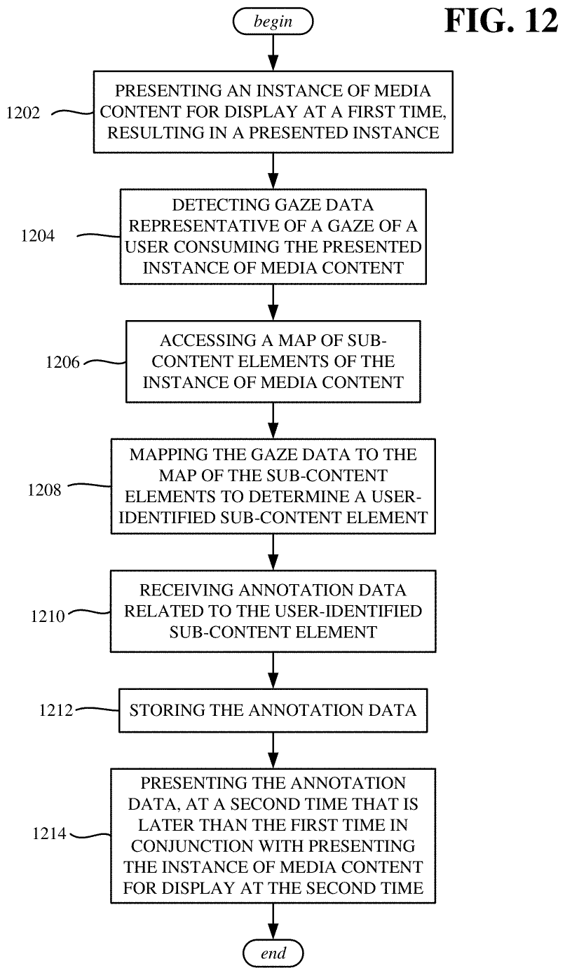

One or more aspects are represented in FIG. 12, such as implemented in a system, including a processor and a memory that stores executable instructions that, when executed by the processor of the system, facilitate performance of operations. Example operation 1202 represents presenting an instance of media content for display at a first time, resulting in a presented instance. Operation 1204 represents detecting gaze data representative of a gaze of a user consuming the presented instance of media content. Operation 1206 represents accessing a map of sub-content elements of the instance of media content. Operation 1208 represents mapping the gaze data to the map of the sub-content elements to determine a user-identified sub-content element. Operation 1210 represents receiving annotation data related to the user-identified sub-content element. Operation 1212 represents storing the annotation data. Operation 1214 represents presenting the annotation data, at a second time that is later than the first time in conjunction with presenting the instance of media content for display at the second time.

Further operations can include outputting a copy of the user-identified sub-content element for a sharing via a social network account.

The user-identified sub-content element can include copyrighted material, and further operations can include facilitating a legal use of the copyrighted material.

Further operations can include outputting the user-identified sub-content element and the annotation data for the sharing via a social network account.

Further operations can include receiving user input associated with the user comprising a command associated with the user-identified sub-content element; outputting of the sub-content element and the annotation data can occur in response to the command.

The map of the sub-content elements can include respective ranges of coordinates defining respective portions of the presented instance of media content.

Presenting of the instance of media content for display can include displaying a page of the media content on an electronic book reader device; mapping of the gaze data to the map of the sub-content elements to determine the user-identified sub-content element can include determining a mapped sub-content element of the page.

Further operations can include prompting the user for user input to confirm the user-identified sub-content element.

Further operations can include highlighting the user-identified sub-content element, and prompting the user for user input to confirm that the user-identified sub-content element is intended for the annotation data.

Receiving of the annotation data related to the user-identified sub-content element can include receiving voice data.

Presenting of the annotation data at the second time can include overlaying the annotation data at a location corresponding to the user-identified sub-content element.

Presenting of the instance of media content for display can include displaying a frameset of video content, and wherein the mapping of the first gaze data to the map of the sub-content elements to determine the user-identified sub-content element comprises determining a mapped portion of the frameset.

Further operations can include receiving a query with respect the user-identified sub-content element, and, in response to the receiving the query, returning response data that answers the query.

Further operations can include recommending, based on the gaze data, the insertion of a bookmark into the instance of the media content.

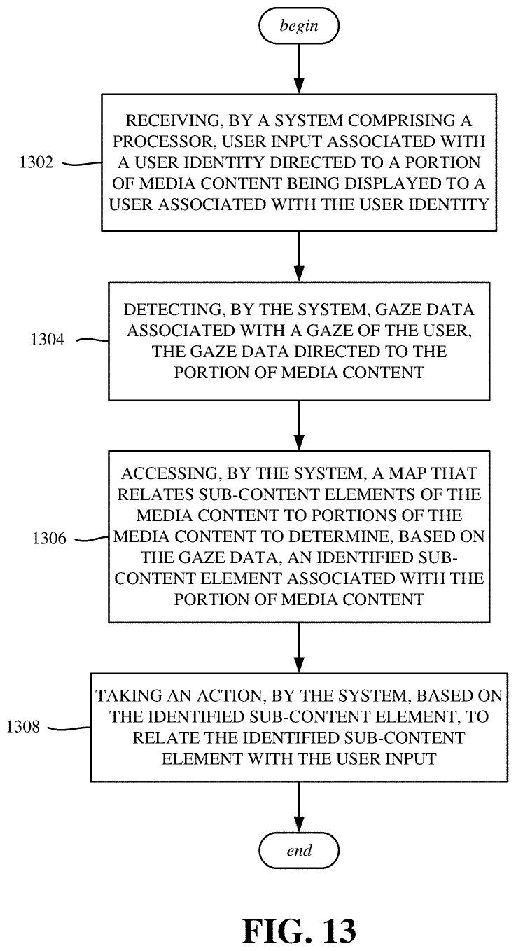

One or more example aspects are represented in FIG. 13, and, for example, can correspond to operations, such as of a method. Example operation 1302 represents receiving, by a system comprising a processor, user input associated with a user identity directed to a portion of media content being displayed to a user associated with the user identity. Operation 1304 represents detecting, by the system, gaze data associated with a gaze of the user, the gaze data directed to the portion of media content. Operation 1306 represents accessing, by the system, a map that relates sub-content elements of the media content to portions of the media content to determine, based on the gaze data, an identified sub-content element associated with the portion of media content. Operation 1308 represents taking an action, by the system, based on the identified sub-content element, to relate the identified sub-content element with the user input.

The user input can include annotation data, and taking the action to relate the identified sub-content element with the user input can include maintaining the annotation data in association with the identified sub-content element.

The user input can include a query, and taking the action to relate the identified sub-content element with the user input can include obtaining information based on the identified sub-content element, and returning a response to the query based on the information.

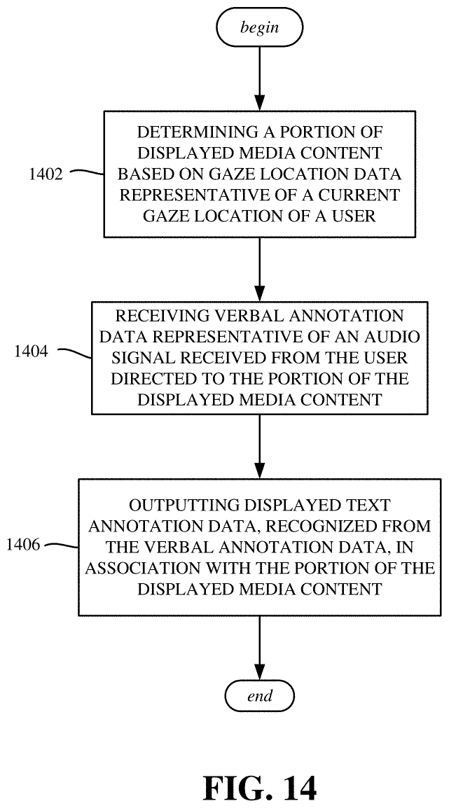

One or more aspects are represented in FIG. 14, such as implemented in a machine-readable medium, including executable instructions that, when executed by a processor, facilitate performance of operations. Example operation 1002 represents determining a portion of displayed media content based on gaze location data representative of a current gaze location of a user. Operation 1404 represents receiving verbal annotation data representative of an audio signal received from the user directed to the portion of the displayed media content. Operation 1406 represents outputting displayed text annotation data, recognized from the verbal annotation data, in association with the portion of the displayed media content.

Further operations can include accessing a map that relates sub-content elements of the media content to portions of the media content to determine an identified sub-content element associated with the portion of the displayed media content; and outputting the displayed text annotation data in association with the portion of the displayed media content can include outputting the displayed text annotation data proximate to the identified sub-content element.

Further operations can include accessing a map that relates sub-content elements of the media content to portions of the media content to determine a first candidate sub-content element associated with the portion of the displayed media content and a second candidate sub-content element associated with the portion of the displayed media content, evaluating content of at least one of the verbal annotation data or the text annotation data to discern an intent of the user in identifying the first candidate sub-content element and not the second candidate sub-content element as being associated with the portion of the displayed media content, and outputting the displayed text annotation data proximate to the first candidate sub-content element.

As can be seen, the technology described herein facilitates user interaction with electronic media content. The technology provides a convenient and straightforward way for users to identify sub-content of displayed media content based on where a user is gazing at the media content. The technology described herein allows for sharing annotation data, and posting annotation data along with related content to social media or the like.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-CDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (including both open-loop and closed-loop), beamforming, and codebook-based precoding can also be used to address issues such as efficiency, interference, and range.

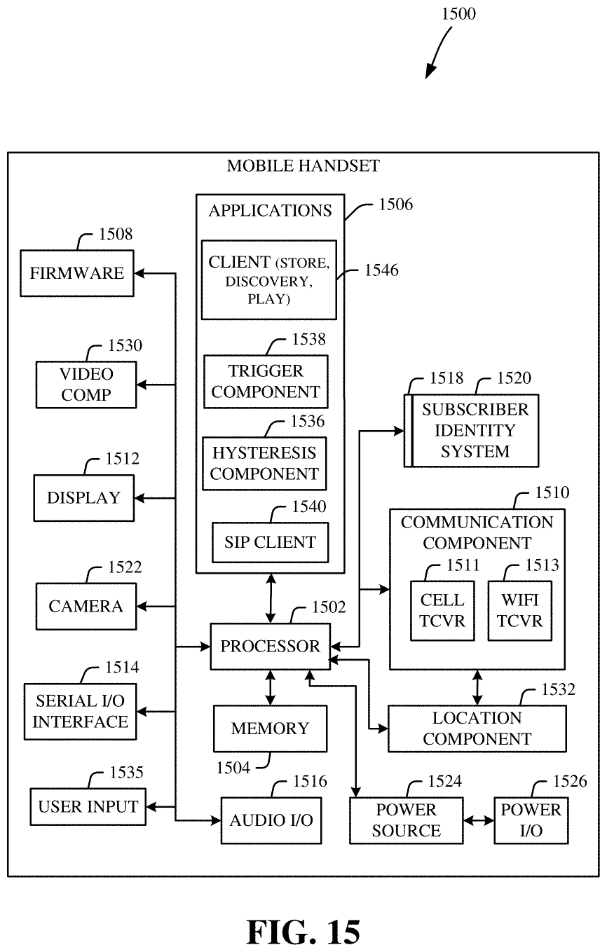

Referring now to FIG. 15, illustrated is a schematic block diagram of an example end-user device (such as user equipment) that can be a mobile device 1500 capable of connecting to a network in accordance with some embodiments described herein. Although a mobile handset 1500 is illustrated herein, it will be understood that other devices can be a mobile device, and that the mobile handset 1500 is merely illustrated to provide context for the embodiments of the various embodiments described herein. The following discussion is intended to provide a brief, general description of an example of a suitable environment 1500 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1500 includes a processor 1502 for controlling and processing all onboard operations and functions. A memory 1504 interfaces to the processor 1502 for storage of data and one or more applications 1506 (e.g., a video player software, user feedback component software, etc.). Other applications can include voice recognition of predetermined voice commands that facilitate initiation of the user feedback signals. The applications 1506 can be stored in the memory 1504 and/or in a firmware 1508, and executed by the processor 1502 from either or both the memory 1504 or/and the firmware 1508. The firmware 1508 can also store startup code for execution in initializing the handset 1500. A communications component 1510 interfaces to the processor 1502 to facilitate wired/wireless communication with external systems, e.g., cellular networks, VoIP networks, and so on. Here, the communications component 1510 can also include a suitable cellular transceiver 1511 (e.g., a GSM transceiver) and/or an unlicensed transceiver 1513 (e.g., Wi-Fi, WiMax) for corresponding signal communications. The handset 1500 can be a device such as a cellular telephone, a PDA with mobile communications capabilities, and messaging-centric devices. The communications component 1510 also facilitates communications reception from terrestrial radio networks (e.g., broadcast), digital satellite radio networks, and Internet-based radio services networks.

The handset 1500 includes a display 1512 for displaying text, images, video, telephony functions (e.g., a Caller ID function), setup functions, and for user input. For example, the display 1512 can also be referred to as a “screen” that can accommodate the presentation of multimedia content (e.g., music metadata, messages, wallpaper, graphics, etc.). The display 1512 can also display videos and can facilitate the generation, editing and sharing of video quotes. A serial I/O interface 1514 is provided in communication with the processor 1502 to facilitate wired and/or wireless serial communications (e.g., USB, and/or IEEE 1594) through a hardwire connection, and other serial input devices (e.g., a keyboard, keypad, and mouse). This supports updating and troubleshooting the handset 1500, for example. Audio capabilities are provided with an audio I/O component 1516, which can include a speaker for the output of audio signals related to, for example, indication that the user pressed the proper key or key combination to initiate the user feedback signal. The audio I/O component 1516 also facilitates the input of audio signals through a microphone to record data and/or telephony voice data, and for inputting voice signals for telephone conversations.

The handset 1500 can include a slot interface 1518 for accommodating a SIC (Subscriber Identity Component) in the form factor of a card Subscriber Identity Module (SIM) or universal SIM 1520, and interfacing the SIM card 1520 with the processor 1502. However, it is to be appreciated that the SIM card 1520 can be manufactured into the handset 1500, and updated by downloading data and software.

The handset 1500 can process IP data traffic through the communication component 1510 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1522 (e.g., a camera) can be provided for decoding encoded multimedia content. The video processing component 1522 can aid in facilitating the generation, editing and sharing of video quotes. The handset 1500 also includes a power source 1524 in the form of batteries and/or an AC power subsystem, which power source 1524 can interface to an external power system or charging equipment (not shown) by a power I/O component 1526.

The handset 1500 can also include a video component 1530 for processing video content received and, for recording and transmitting video content. For example, the video component 1530 can facilitate the generation, editing and sharing of video quotes. A location tracking component 1532 facilitates geographically locating the handset 1500. As described hereinabove, this can occur when the user initiates the feedback signal automatically or manually. A user input component 1534 facilitates the user initiating the quality feedback signal. The user input component 1534 can also facilitate the generation, editing and sharing of video quotes. The user input component 1534 can include such conventional input device technologies such as a keypad, keyboard, mouse, stylus pen, and/or touch screen, for example.

Referring again to the applications 1506, a hysteresis component 1536 facilitates the analysis and processing of hysteresis data, which is utilized to determine when to associate with the access point. A software trigger component 1538 can be provided that facilitates triggering of the hysteresis component 1538 when the Wi-Fi transceiver 1513 detects the beacon of the access point. A SIP client 1540 enables the handset 1500 to support SIP protocols and register the subscriber with the SIP registrar server. The applications 1506 can also include a client 1542 that provides at least the capability of discovery, play and store of multimedia content, for example, music.

The handset 1500, as indicated above related to the communications component 810, includes an indoor network radio transceiver 1513 (e.g., Wi-Fi transceiver). This function supports the indoor radio link, such as IEEE 802.11, for the dual-mode GSM handset 1500. The handset 1500 can accommodate at least satellite radio services through a handset that can combine wireless voice and digital radio chipsets into a single handheld device.

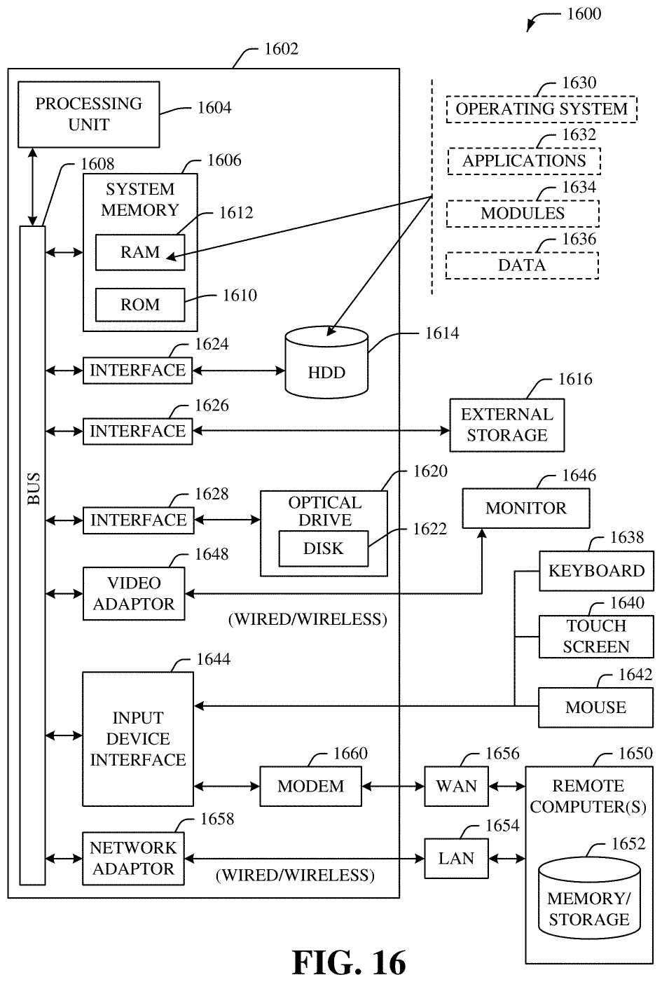

In order to provide additional context for various embodiments described herein, FIG. 16 and the following discussion are intended to provide a brief, general description of a suitable computing environment 1600 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid state drive (SSD), non-volatile memory and other storage technology could be used in addition to, or in place of, an HDD 1614, and can be internal or external. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1594 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally include emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can include one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enabled with a security module, such as a trusted processing module (TPM). For instance with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1594 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 16 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a processor; and
a memory that stores executable instructions that, when executed by the processor of the system, facilitate performance of operations, the operations comprising:
presenting an instance of media content for display at a first time, resulting in a presented instance;
detecting gaze data representative of a gaze of a user consuming the presented instance of media content;
accessing a map of sub-content elements of the instance of media content;
mapping the gaze data to the map of the sub-content elements to determine a user-identified sub-content element;
receiving annotation data related to the user-identified sub-content element;
storing the annotation data; and
presenting the annotation data, at a second time that is later than the first time in conjunction with presenting the instance of media content for display at the second time.

2. The system of claim 1, wherein the operations further comprise outputting a copy of the user-identified sub-content element for a sharing via a social network account.

3. The system of claim 2, wherein the user-identified sub-content element comprises copyrighted material, and wherein the operations further comprise facilitating a legal use of the copyrighted material.

4. The system of claim 1, wherein the operations further comprise outputting the user-identified sub-content element and the annotation data for the sharing via a social network account.

5. The system of claim 4, wherein the operations further comprise receiving user input associated with the user comprising a command associated with the user-identified sub-content element, and wherein the outputting of the sub-content element and the annotation data occurs in response to the command.

6. The system of claim 1, wherein the map of the sub-content elements comprises respective ranges of coordinates defining respective portions of the presented instance of media content.

7. The system of claim 1, wherein the presenting of the instance of media content for display comprises displaying a page of the media content on an electronic book reader device, and wherein the mapping of the gaze data to the map of the sub-content elements to determine the user-identified sub-content element comprises determining a mapped sub-content element of the page.

8. The system of claim 1, wherein the operations further comprise prompting the user for user input to confirm the user-identified sub-content element.

9. The system of claim 1, wherein the operations further comprise highlighting the user-identified sub-content element, and prompting the user for user input to confirm that the user-identified sub-content element is intended for the annotation data.

10. The system of claim 1, wherein the receiving of the annotation data related to the user-identified sub-content element comprises receiving voice data.

11. The system of claim 1, wherein the presenting of the annotation data at the second time comprises overlaying the annotation data at a location corresponding to the user-identified sub-content element.

12. The system of claim 1, wherein the presenting of the instance of media content for display comprises displaying a frameset of video content, and wherein the mapping of the first gaze data to the map of the sub-content elements to determine the user-identified sub-content element comprises determining a mapped portion of the frameset.

13. The system of claim 1, wherein the operations further comprise receiving a query with respect the user-identified sub-content element, and, in response to the receiving the query, returning response data that answers the query.

14. The system of claim 1, wherein the operations further comprise recommending, based on the gaze data, the insertion of a bookmark into the instance of the media content.

15. A method, comprising,
receiving, by a system comprising a processor, user input associated with a user identity directed to a portion of media content being displayed to a user associated with the user identity;
detecting, by the system, gaze data associated with a gaze of the user, the gaze data directed to the portion of media content;
accessing, by the system, a map that relates sub-content elements of the media content to portions of the media content to determine, based on the gaze data, an identified sub-content element associated with the portion of media content; and
taking an action, by the system, based on the identified sub-content element, to relate the identified sub-content element with the user input.

16. The method of claim 15, wherein the user input comprises annotation data, and wherein the taking of the action to relate the identified sub-content element with the user input comprises maintaining the annotation data in association with the identified sub-content element.

17. The method of claim 15, wherein the user input comprises a query, and wherein the taking of the action to relate the identified sub-content element with the user input comprises obtaining information based on the identified sub-content element, and returning a response to the query based on the information.

18. A non-transitory machine-readable medium, comprising executable instructions that, when executed by a processor, facilitate performance of operations, the operations comprising:
determining a portion of displayed media content based on gaze location data representative of a current gaze location of a user;
receiving verbal annotation data representative of an audio signal received from the user directed to the portion of the displayed media content; and
outputting displayed text annotation data, recognized from the verbal annotation data, in association with the portion of the displayed media content.

19. The non-transitory machine-readable medium of claim 18, wherein the operations further comprise accessing a map that relates sub-content elements of the media content to portions of the media content to determine an identified sub-content element associated with the portion of the displayed media content, and wherein the outputting of the displayed text annotation data in association with the portion of the displayed media content comprises outputting the displayed text annotation data proximate to the identified sub-content element.

20. The non-transitory machine-readable medium of claim 18, wherein the operations further comprise accessing a map that relates sub-content elements of the media content to portions of the media content to determine a first candidate sub-content element associated with the portion of the displayed media content and a second candidate sub-content element associated with the portion of the displayed media content, evaluating content of at least one of the verbal annotation data or the text annotation data to discern an intent of the user in identifying the first candidate sub-content element and not the second candidate sub-content element as being associated with the portion of the displayed media content, and outputting the displayed text annotation data proximate to the first candidate sub-content element.
